(19) United States
(12) Patent Application Publication
(10) Pub. No.: US 2022/0261282 A1
(43) Pub. Date: Aug. 18, 2022

(54) INFORMATION PROCESSING APPARATUS, INFORMATION PROCESSING METHOD, AND COMPUTER-READABLE RECORDING MEDIUM STORING INFORMATION PROCESSING PROGRAM

(71) Applicant: FUJITSU LIMITED, Kawasaki-shi (JP)

(72) Inventors: Kenichi Nagasue, Fukuoka (JP); Kouichirou Amemiya, Kawasaki (JP)

(73) Assignee: FUJITSU LIMITED, Kawasaki-shi (JP)

(21) Appl. No.: 17/524,875

(22) Filed: Nov. 12, 2021

(30) Foreign Application Priority Data
Feb. 15, 2021 (JP) 2021-022087

(51) Int. Cl. G06F 9/48; G06F 9/30; G06F 9/50

(52) U.S. Cl. CPC G06F 9/4887; G06F 9/5072; G06F 9/30029

(57) ABSTRACT

An information processing apparatus includes a memory, and a processor coupled to the memory and configured to classify tasks for data collection into groups, the tasks each being for a corresponding one of a plurality of devices, allocate, for each of the groups, each of first values of which an accumulated value for all of the tasks in the group is equal to a predetermined value, to each of the tasks in the group, accumulate, for each of the groups, the first value allocated to the task in a case where data that corresponds to the task is received from the device, and update states of the tasks in the group to a completed state in a case where the accumulated value for the group is equal to the predetermined value.

### CROSS-REFERENCE TO RELATED APPLICATION

This application is based upon and claims the benefit of priority of the prior Japanese Patent Application No. 2021-22087, filed on Feb. 15, 2021, the entire contents of which are incorporated herein by reference.

### FIELD

The embodiment discussed herein is related to an information processing apparatus, an information processing method, and a computer-readable recording medium storing an information processing program.

### BACKGROUND

As an example of a data collection system, a platform for collecting data from distributed devices, for example, Internet of Things (IoT) devices, is known. For example, from the perspective of taking an action when a delay occurs, a data collection system manages a status of data collection from a device and monitors whether there is a delay from the data collection status.

Japanese Laid-open Patent. Publication No. 2020-27652 and Japanese Laid-open Patent Publication No. 2006-51391 are disclosed as related art.

### SUMMARY

According to an aspect of the embodiments, an information processing apparatus includes a memory, and a processor coupled to the memory and configured to classify tasks for data collection into groups, the tasks each being for a corresponding one of a plurality of devices, allocate, for each of the groups, each of first values of which an accumulated value for all of the tasks in the group is equal to a predetermined value, to each of the tasks in the group, accumulate, for each of the groups, the first value allocated to the task in a case where data that corresponds to the task is received from the device, and update states of the tasks in the group to a completed state in a case where the accumulated value for the group is equal to the predetermined value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a configuration of a system according to an embodiment;

FIG. 2 is a diagram illustrating a functional configuration of a distributed data collection system;

FIG. 3 is a diagram illustrating an example of request information;

FIG. 4 is a diagram illustrating an example of task information;

FIG. 5 is a diagram illustrating an example of grouping of tasks;

FIG. 6 is a diagram illustrating an example of group information;

FIG. 7 is a diagram illustrating an example of allocation of a bit string to each task;

FIG. 8 is a diagram illustrating an example of data of edited task information;

FIG. 9 is a flowchart illustrating a procedure performed at the time of acceptance of a transmission request from a service providing system;

FIG. 18 is a flowchart illustrating a procedure performed at the time of reception of data;

FIG. 11 is a flowchart illustrating a procedure performed at the time of monitoring; and

FIG. 12 is a diagram illustrating an example of a hardware configuration of a computer.

### DESCRIPTION OF EMBODIMENTS

In the related art, management of a data collection status, monitoring of presence or absence of a delay, and the like are performed in units of data collection tasks allocated to devices. Thus, there is a perspective that resources used for monitoring a delay or the like increase.

An embodiment of a technique capable of reducing resources used for monitoring a delay or the like will be described below with reference to the accompanying drawings. Note that this embodiment does not intend to limit the disclosed technique.

### Embodiment

[1. System Configuration]

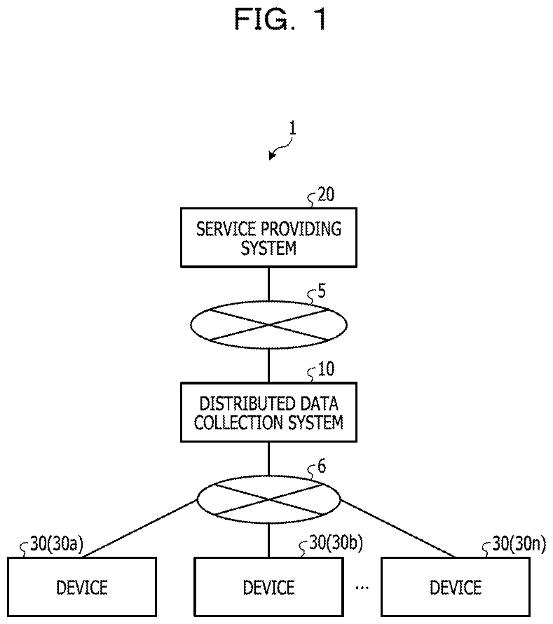

FIG. 1 is a diagram illustrating an example of a configuration of a system according to an embodiment. As illustrated in FIG. 1, a system 1 may include a distributed data collection system 10, a service providing system 20, and a plurality of devices 30 (devices 30a, 30b, 30n). The distributed data collection system 10 and the service providing system 20 are communicably coupled to each other via a network 5. The distributed data collection system 10 and the plurality of devices 30 are communicably coupled to each other via a network 6. For example, the networks 5 and 6 may be communication networks of arbitrary kinds such as Internet and a local area network (LAN) regardless of whether they are wired or wireless.

The service providing system 20 is an example of a computer that provides a predetermined service. An example of such a service may be a function of providing information related to car insurance. For example, in a case where an occurrence of a car accident is detected at a certain point, the service providing system 20 requests the distributed data collection system 10 to transmit a video of the point, and acquires the video of the point where the accident has occurred from the distributed data collection system 10. The service providing system 20 is not limited to the aforementioned system that manages information for providing a service related to car insurance but may be a system that provides various services. For example, the service providing system 20 may be a map information system that manages map information including images and video information of individual points.

The distributed data collection system 10 is an example of a computer that collects data from the devices 30 in response to a transmission request from the service providing system 20. The distributed data collection system 10 is, for example, an information processing apparatus such as a server apparatus. In response to a transmission request from the service providing system 20, the distributed data collection system 10 makes a data transmission request to the plurality of devices 30 and thus causes the plurality of devices 30 to transmit data corresponding to the transmission request from the service providing system 20. In response to receipt of the data from the devices 30, the distributed data collection system 10 transmits the data to the service providing system 20.

The devices 30 may be arbitrary IoT devices. In response to a data transmission request from the distributed data collection system 10, the devices 30 each transmit corresponding data to the distributed data collection system 10. For example, the devices 30 may correspond to onboard devices each including a drive recorder mounted on a vehicle. The drive recorder may be equipped with a Global Positioning System (GPS) receiver. The onboard devices are merely an example, and the devices 30 may be arbitrary computers such as mobile terminal devices or wearable terminals.

The devices 30 may not only transmit data in response to a data transmission request from the distributed data collection system 10 but also transmit information related to the devices 30 to the distributed data collection system 10 or another computer at intervals of a predetermined period. For example, when each of the devices 30 is a drive recorder mounted on a vehicle, the device 30 transmits information for identifying the device 30 and information indicating a current location of the device 30. The device 30 also transmits information related to a video captured by the device 30 (for example, information indicating an image-capturing location and an image-capturing time, a file name, a file size, and so on) and information indicating a communication status (for example, a radio field intensity).

[2. Functional Configuration of Distributed Data Collection System 10]

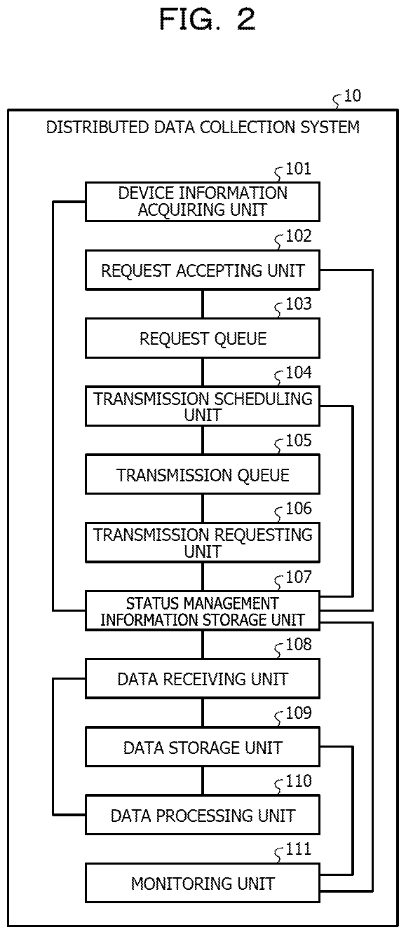

A functional configuration of the distributed data collection system 10 will be described next by using FIG. 2. FIG. 2 is a diagram illustrating a functional configuration of the distributed data collection system 10. FIG. 2 schematically illustrates blocks corresponding to functions of the distributed data collection system 10. However, the distributed data collection system 10 may include other functions. In FIG. 2, some of units having an input/output relationship between the individual blocks are coupled. However, the input/output relationship between the individual blocks is not limited to the illustrated example. As illustrated in FIG. 2, the distributed data collection system 10 includes a device information acquiring unit 101, a request accepting unit 102, a request queue 103, a transmission scheduling unit 104, and a transmission queue 105. The distributed data collection system 10 also includes a transmission requesting unit 106, a status management information storage unit 107, a data receiving unit 108, a data storage unit 109, a data processing unit 110, and a monitoring unit 111. The distributed data collection system 10 may be implemented by a single information processing apparatus or by a plurality of information processing apparatuses.

The device information acquiring unit 101 is a processing unit that acquires information related to the devices 30. The device information acquiring unit 101 acquires, from each of the devices 30, for example, information for identifying the device 30, information indicating the current location of the device 30, information related to a video captured by the device 30, and information indicating the communication status at intervals of a predetermined period. The device information acquiring unit 101 acquires the information (communication status information) indicating the communication status of the devices 30 in this manner, and thus functions as a communication status information acquiring unit. The device information acquiring unit 101 may acquire the information related to the devices 30 from another computer that stores the information related to the devices 30. The device information acquiring unit 101 registers device information, which is information in which the acquired information is managed for each of the devices 30, in the status management information storage unit 107.

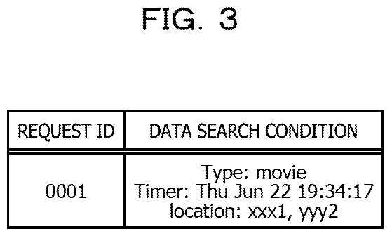

The request accepting unit 102 is a processing unit that accepts a transmission request from the service providing system 20 and determines the device(s) 30 to which a data transmission request is to be made. The request accepting unit 102 is an example of an allocating unit. For example, the request accepting unit 102 is implemented by an application programming interface (API) for data collection. The request accepting unit 102 accepts the aforementioned transmission request by acquiring, together with the aforementioned transmission request, request information including a condition for data to be requested. An example of the request information will be described by using FIG. 3.

FIG. 3 is a diagram illustrating an example of the request information. As illustrated in FIG. 3, the request information includes a request identifier (ID) that is information for identifying a request, and a data search condition that is a condition for data to be requested. In the case of the example illustrated in FIG. 3, the request ID is “0001”. The example illustrated in FIG. 3 also indicates that the data search condition for data to be searched for is video data including video data captured at a time of 19:34:17 on June 22 (Thursday) at an image-capturing location whose latitude and longitude are (xxx1, yyy2).

In response to accepting the transmission request from the service providing system 20, the request accepting unit 102 searches for the devices 30 that match the data search condition included in the request information. For example, the request accepting unit 102 refers to the device information stored in the status management information storage unit 107, and searches for the devices 30 for which information related to the videos captured by the respective devices 30 (the image-capturing locations and the image-capturing times) matches the data search condition illustrated in FIG. 3. The distributed data collection system 10 makes a video transmission request to all the devices 30 that match the data search condition by making the video transmission request to the devices 30 found in the search.

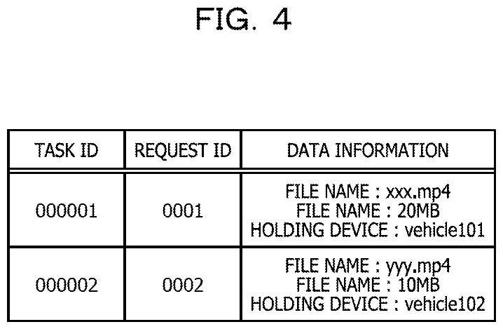

For each of the devices 30 found in the search, the request accepting unit 102 generates task information that is information in which the information related to the device 30 found in the search and the request ID are associated with each other. The task information will be described by using FIG. 4. FIG. 4 is a diagram illustrating an example of the task information. As illustrated in FIG. 4, the task information includes a task ID that is information for identifying a task, a request ID, and data information that is the information related to the device 30 found in the search.

The task ID is information for identifying each task, and is generated at the time of generation of the task information. The data information includes a file name, a file size, and a holding device. The file name is a file name included in information related to the video captured by the device 30 found in the search. The file size is a file size included in the information related to the video captured by the device 30 found in the search. The holding device is identification information of the device 30 found in the search. In response to a transmission request (service request), the distributed data collection system 10 divides the request for each device and manages the divisional requests as tasks in this manner.

The request accepting unit 102 sets, for each task, a timeout time that is a time at which it is determined whether a delay in a response to the request has occurred. For example, the request accepting unit 102 sets the timeout time by estimating, based on the information indicating the latest communication status of the device 30 corresponding to each task in the device information, a completion time and by adding a predetermined buffer time (margin) to the estimated time.

For example, in a case where it is indicated that the radio field intensity, which is the information indicating the communication status of the device 30 corresponding to a certain task, is weak, the request accepting unit 102 sets the completion time to a later time. As described above, the request accepting unit 102 determines the completion time of the task by calculating the network connectivity by using the radio field intensity estimated from the physical location of the device 30.

The request accepting unit 102 groups the individual tasks, based on the timeout times of the respective tasks. For example, the request accepting unit 102 groups the timeout times for each certain period, and sets tasks whose timeout times are reached in the period of the group as tasks belonging to the group. As described above, the request accepting unit 102 sets, based on the information indicating the communication status of the device 30, the timeout time, and groups, based on the timeout time, each task. Thus, by grouping tasks of the devices 30 having similar communication statuses into the same group, the distributed data collection system 10 performs grouping so that the tasks are easily managed.

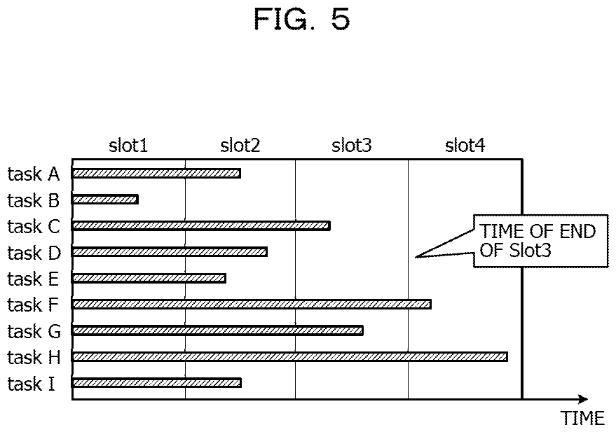

An example of grouping of tasks based on timeout times will be described by using FIG. 5. FIG. 5 is a diagram illustrating an example of grouping of tasks. FIG. 5 illustrates timeout times of respective tasks by using a bar graph. In the example illustrated in FIG. 5, the request accepting unit 102 generates groups for respective periods “slot1” to “slot4”, and sets, based on the individual periods and the timeout times of the respective tasks, a group to which each of the tasks belongs.

For example, the request accepting unit 102 sets “task C” and “task G” as tasks belonging to a group for the period “slot3”. As described above, the request accepting unit 102 sets a timeout time for each of the devices 30 that are destinations of a data transmission request, and performs grouping based on the timeout times of the respective devices 30.

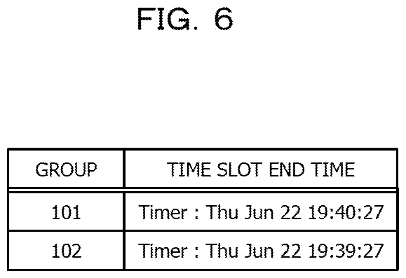

The request accepting unit 102 generates group information in which information for identifying each group and an end time (time of the end) of a period for the group are associated with each other. FIG. 6 illustrates an example of the group information. FIG. 6 is a diagram illustrating an example of the group information. As illustrated in FIG. 6, the group information includes a group ID that is the information for identifying a group, and a time slot end time. The time slot end time is the end time of a period for the corresponding group.

The request accepting unit 102 sets values for tasks belonging to each group. For example, the request accepting unit 102 sets a value for each of the devices 30 belonging to each group. For example, the request accepting unit 102 generates bit strings so that the exclusive OR of all the values allocated to respective tasks belonging to a group is equal to a predetermined value (for example, 00000000), and allocates the bit strings to the respective tasks. A technique for generating bit strings of which the exclusive OR is equal to a predetermined value in this manner may be implemented by employing a known technique.

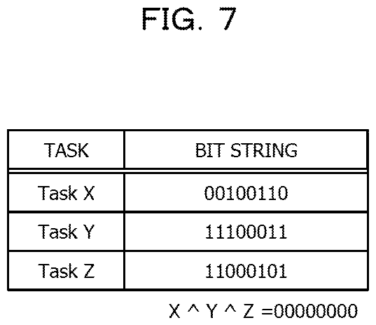

FIG. 7 illustrates an example of allocation of a bit string to each task. In the example illustrated in FIG. 7, the request accepting unit 102 sets a bit string “00100110” to a task “Task X”. The request accepting unit 102 sets a bit string “11100011” to a task “Task Y”. The request accepting unit 102 sets a bit string “11000101” to a task “Task Z”. In this case, the exclusive OR of the bit strings of the respective tasks is equal to “00000000”.

The request accepting unit 102 edits the task information generated as described above so that a group (for example, a group ID), a bit string, a timeout time, and a task state are associated with the task information, and registers the edited task information in the status management information storage unit 107. In this manner, the request accepting unit 102 generates the task information including the task state, the group to which the device 30 belongs, the bit string set or the device 30, and the timeout time for the device 30.

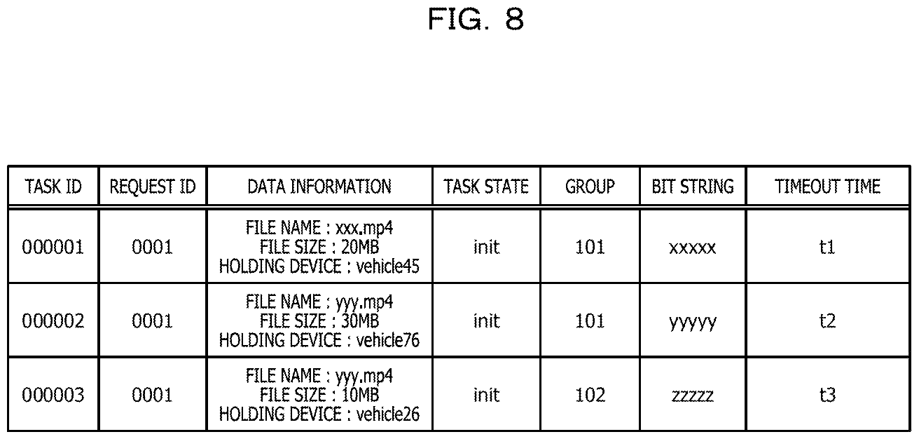

The request accepting unit 102 inputs the edited task information to the request queue 103. FIG. 8 illustrates an example of data of the edited task information. As illustrated in FIG. 8, the task information includes the task ID, the request ID, the data information, the task state, the group, the bit string, and the timeout time. The task state is information indicating the state of the task such as the data transmission status of each of the devices 30. At the time when the task information is input to the request queue 103, the task state is set to “init” that indicates the initial state.

Referring back to FIG. 2, the request queue 103 is an example of a storage area for storing the task information. For example, the request queue 103, which serves as a request queue, stores the task information input from the request accepting unit 102.

The transmission scheduling unit 104 is a processing unit that sets a transmission schedule for the task information stored in the request queue 103. The transmission scheduling unit 104 acquires the task information from the request queue 103 at a predetermined timing. The transmission scheduling unit 104 sets a transmission order of individual pieces of task information. For example, the transmission scheduling unit 104 sets the transmission order of the pieces of task information in an order of the timeout times.

After setting the transmission order of the individual pieces of task information, the transmission scheduling unit 104 changes the task states of the respective pieces of task information, stored in the status management information storage unit 107, corresponding to the pieces of task information for which the transmission order is set, to “scheduled”. This “scheduled” indicates a scheduling completed state.

After changing the task states of the pieces of task information stored in the status management information storage unit 107, the transmission scheduling unit 104 inputs, to the transmission queue 105, the pieces of task information acquired from the request queue 103.

The transmission queue 105 is a storage area for storing the task information for which the transmission schedule has been set. For example, the transmission queue 105, which serves as a transmission queue, stores the task information input from the transmission scheduling unit 104.

The transmission requesting unit 106 is a processing unit that makes a data transmission request to the devices 30 that are destinations of the data transmission request. The transmission requesting unit 106 acquires the pieces of task information stored in the transmission queue 105, and changes the task states of the respective pieces of task information, stored in the status management information storage unit 107, corresponding to the acquired pieces of task information, to “issued”. This “issued” indicates a data transmitting state.

After changing the task states of the respective pieces of task information stored in the status management information storage unit 107, the transmission requesting unit 106 transmits the corresponding piece of task information to each of the devices 30 and makes a data transmission request. The transmission requesting unit 106 changes the task states of the respective pieces of task information, stored in the status management information storage unit 107, corresponding to the data transmission request, to “pushed”. This “pushed” indicates that data transmission has been requested.

The status management information storage unit 107 is an example of a storage unit for storing the device information that is the information related to the device 30, the information related to the group, and the task information.

The data receiving unit 108 is a processing unit that receives data (for example, video data) from the device 30. The data receiving unit 108 is an example of an accumulating unit and an updating unit. The data receiving unit 108 also receives the task information including the request ID, the group, and the bit string from the device 30 that has transmitted the video data. The data receiving unit 108 registers the received task information in association with the video data received from the device 30 in the data storage unit 109. The data receiving unit 108 notifies the data processing unit 110 that the data has been registered in the data storage unit 109.

The data receiving unit 108 generates information indicating progress of the group to which the device 30 that is the transmission source of the video data belongs. For example, the data receiving unit 108 refers to the task information received from the device 30, and newly generates progress information including information indicating progress if the data receiving unit 108 does not have information indicating progress that matches a predetermined condition. The progress information is information in which the request ID, the group (for example, the group ID), and a variable for inputting a bit string are associated with one another. The condition is that the request ID is the same as the request ID of the task information and the group is the same as the group of the task information.

If the data receiving unit 108 holds the progress information for the same request ID and the same group, the data receiving unit 108 calculates the exclusive OR of the bit string of the variable in the progress information and the bit string of the task information received by the data receiving unit 108. The data receiving unit 108 determines whether a result of calculating the exclusive OR of the bit string of the variable in the progress information and the bit string of the task information received by the data receiving unit 108 is equal to “00000000”. If the exclusive OR is not equal to “00000000” as a result of the determination, the data receiving unit 108 holds the value of the calculated exclusive OR as the bit string in the progress information.

If the exclusive OR is equal to “00000000” as a result of the data receiving unit 108 calculating the exclusive OR of the bit string of the variable in the progress information and the bit string of the task information received by the data receiving unit 108, the data receiving unit 108 refers to the task information stored in the status management information storage unit 107. The data receiving unit 108 changes the task state of the task information, stored in the status management information storage unit 107, in which the request ID is the same as the request ID of the received task information and the group is the group of the received task information, to “completed”.

As described above, the request accepting unit 102 generates bit strings so that the exclusive OR of all the values allocated to the respective tasks belonging to the group is equal to “00000000”, and allocates the bit strings to the respective tasks. If the exclusive OR is equal to “00000000” as a result of calculating the exclusive OR of the bit string in the progress information and the bit string of the task information received by the data receiving unit 108, this indicates that data has been received from all the devices 30 in the same group. Thus, the data receiving unit 108 changes the task state of the task information as described above.

In this manner, the data receiving unit 108 determines whether data has been received from all the devices 30 in the same group, by using the calculation result of the bit string in the progress information and the bit string of the task information received by the data receiving unit 108. Thus, the data receiving unit 108 generates the calculation result as information indicating the progress. The data receiving unit 108 manages the task state of the task information, based on the calculation result. For example, the data receiving unit 108 updates the task states of the task information in units of groups.

The data receiving unit 108 may keep holding data for which the bit string in the progress information is equal to “00000000” in order for the monitoring unit 111 (described later) to identify the group for which the tasks are completed.

The data storage unit 109 is an example of a storage unit for storing data received from the device 30. The data storage unit 109 stores information in which the task information and the video data received from the device 30 are associated with each other.

The data processing unit 110 is a processing unit that transmits the data stored in the data storage unit 109 to the service providing system 20 at a predetermined timing. The data processing unit 110 transmits the video data from the data storage unit 109 to the service providing system 20 after an elapse of a predetermined time since receipt of a request from the service providing system 20. Each time the data processing unit 110 is notified by the data receiving unit 108 that the video data is stored in the data storage unit 109, the data processing unit 110 may transmit the video data to the service providing system 20.

The monitoring unit 111 is a processing unit that identifies, if the timeout time corresponding to the group has passed, the device 30 that has not transmitted video data among the devices 30 belonging to the group and performs delay processing. The timeout time corresponding to the group is the time slot end time of the group.

The monitoring unit 111 acquires pieces of group information each including a target request ID at a predetermined timing (for example, at intervals of a predetermined period). The monitoring unit 111 excludes, from monitoring targets, a piece of group information for which the bit string in the progress information held in the data processing unit 110 is equal to “00000000” among the acquired pieces of group information.

The monitoring unit 111 determines whether the current time is after the time slot end time of the monitoring-target group information. If the current time is after the time slot end time in the monitoring-target group information, the monitoring unit 111 monitors tasks belonging to the group corresponding to the group information.

For example, the monitoring unit 111 refers to the status management information storage unit 107 and acquires pieces of task information including the group ID of the monitoring target group information. The monitoring unit 111 refers to the data storage unit 109 and determines whether video data associated with each piece of task information is saved. If the video data is saved, the monitoring unit 111 changes the task state of the piece of task information stored in the status management information storage unit 107, to “completed”.

On the other hand, as a result of referring to the data storage unit 109 and determining whether the video data associated with each piece of task information is saved, if the video data is not saved, the monitoring, unit 111 performs predetermined delay processing. This is because the fact that the video data associated with the piece of task information is not saved indicates that the video data has not been not acquired from the device 30 corresponding to the task. The delay processing is processing for coping with a delay in data reception. For example, the monitoring unit 111 retransmits a data transmission request to the device 30 or updates the task state of the piece of task information to information indicating “not-received”, as the delay processing.

As described above, if the timeout time corresponding to the monitoring-target group has passed, the monitoring unit 111 identifies the device 30 that has not transmitted the data from among the devices 30 belonging to the group, and performs the delay processing. The monitoring unit 111 narrows down all the devices 30 belonging to the group to a device from which data is not received, and performs the delay processing on the device 30 that has not transmitted the data. Thus, the distributed data collection system 10 may efficiently check whether data is received from the devices 30.

[3. Processing Flows]

[3.1 Processing Flow at Time of Acceptance of Transmission Request from Service Providing System]

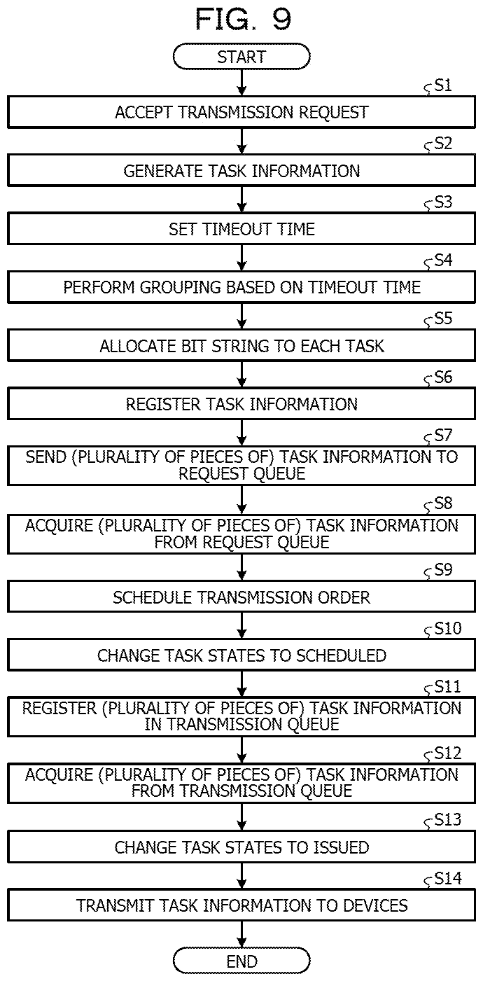

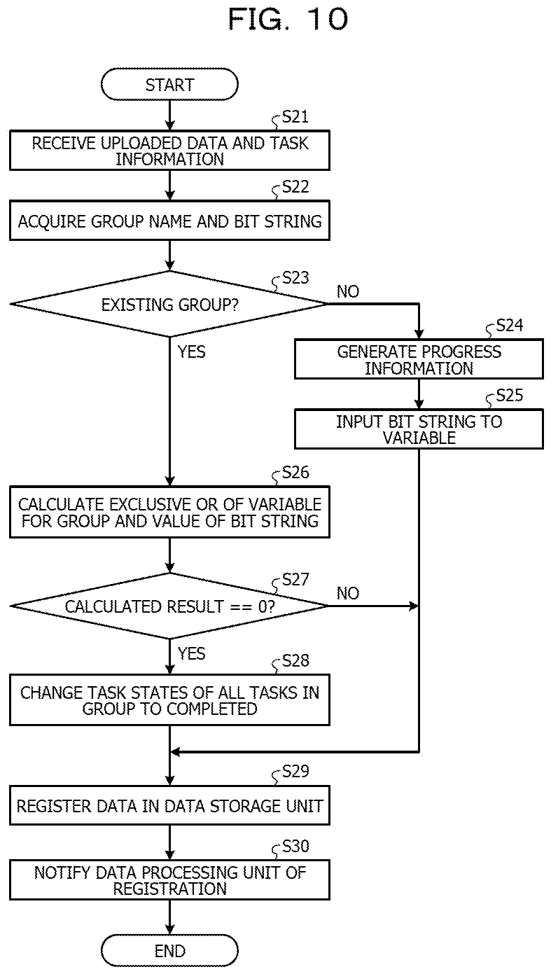

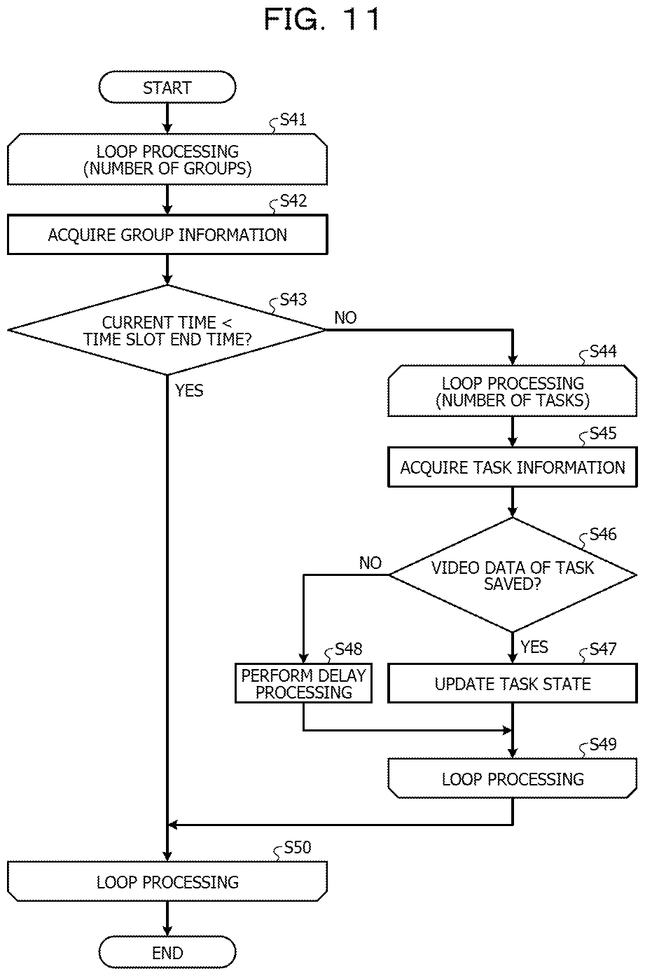

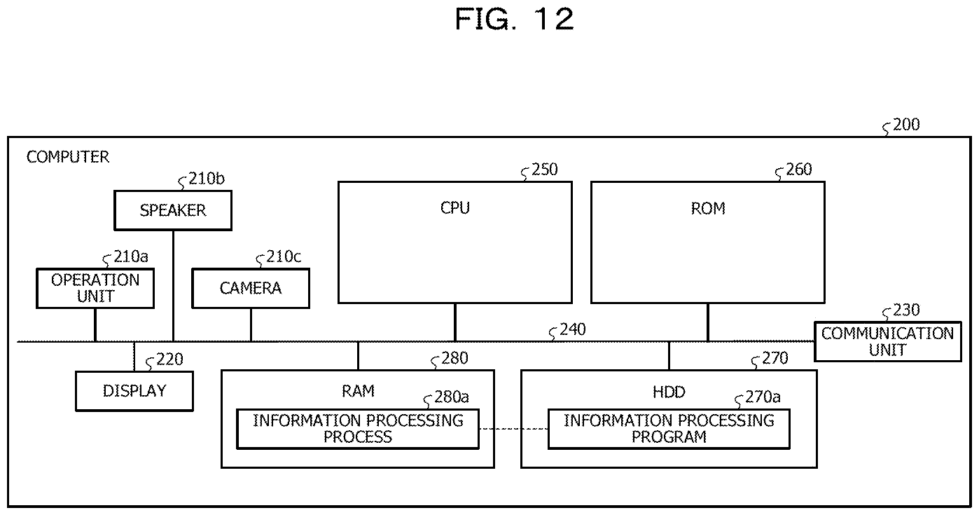

FIG. 9 is a flowchart illustrating a procedure performed at the time of acceptance of a transmission request from the service providing system 20. The request accepting unit 102 accepts a transmission request from the service providing system 20 (operation S1). In response to the transmission request, the request accepting unit 102 searches for the devices 30 that correspond to a condition for data and generates, for each of the devices 30 found in the search, task information that is information in which information related to the device 30 and the request ID are associated with each other (operation S2).

The request accepting unit 102 sets a timeout time for each task (operation S3). The request accepting unit 102 performs grouping based on the timeout time (operation S4). The request accepting unit 102 allocates a bit string to each task (operation S5). The request accepting unit 102 registers the task information in the status management information storage unit 107 (operation 56). The request accepting unit 102 sends the generated task information to the request queue 103 (operation S7).

The transmission scheduling unit 104 acquires the pieces of task information in the request queue 103 at a predetermined timing (operation S8), and schedules a transmission order of the pieces of task information (operation S9). After setting the transmission order of the individual pieces of task information, the transmission scheduling unit 104 changes the task states of the respective pieces of task information, stored in the status management information storage unit 107, corresponding to the pieces of task information for which the transmission order is set, to “scheduled” (operation S10). The transmission scheduling unit 104 registers the pieces of task information for which transmission has been scheduled in the transmission queue 105 (operation 511).

The transmission requesting unit 106 acquires the pieces of task information stored in the transmission queue 105 (operation S12), and changes the task states of the respective pieces of task information, stored in the status management information storage unit 107, corresponding to the acquired pieces of task information, to “issued” (operation S13). After changing the task states of the respective pieces of task information stored in the status management information storage unit 107, the transmission requesting unit 106 transmits the corresponding piece of task information to each of the devices 30 and makes a data transmission request (operation S14). The transmission requesting unit 106 changes the task states of the respective pieces of task information, stored in the status management information storage unit 107, corresponding to the data transmission request, to “pushed”.

[3.2 Processing Flow at Time of Reception of Data]

A processing flow at the time of reception of data will be described next by using FIG. 10. FIG. 10 is a flowchart illustrating a procedure performed at the time of reception of data. The expression “reception of data” used herein refers to processing of receiving video data from the device 30. The data receiving unit 108 receives uploaded data (video data) and task information from the device 30 (operation S21). The data receiving unit 108 acquires the group and the bit string from the task information (operation S22). The data receiving unit 108 determines whether progress information for the group is held. For example, the data receiving unit 108 determines whether the group is an existing group (operation S23).

If the data receiving unit 108 determines that the group acquired from the task information is not an existing group (operation S23: No), the data receiving unit 108 generates, for the group, progress information including a variable for inputting a bit string (operation S24). The data receiving unit 108 inputs the bit string acquired from the task information to the variable for inputting a bit string (operation S25). The processing then proceeds to operation S29.

If the data receiving unit 108 determines in operation S23 that the group acquired from the task information is an existing group (operation S23: Yes), the data receiving unit 108 calculates the exclusive OR of the variable of the progress information and the bit string of the task information (operation S26). The data receiving unit 108 determines whether the calculated result is equal to 0 (operation S27).

The calculated result of 0 indicates that all bits of the calculated bit string are equal to 0 (for example, “00000000”). If the data receiving unit 108 determines that the calculated result is not equal to 0 (operation S27: No), the processing proceeds to operation S29.

If the data receiving unit 108 determines that the calculation result is equal to 0 (operation S27: Yes), the data receiving unit 108 changes the task states of the respective pieces of task information, stored in the status management information storage unit 107, for the devices 30 belonging to the group of the received task information, to “completed”. For example, the data receiving unit 108 changes the task states of the respective pieces of task information in which the request ID of the task information is the same as the request ID of the received task information and the group of the task information is the same as the group of the received task information (operation S28).

In operation S29, the data receiving unit 108 registers the received task information and the video data received from the device 30 in the data storage unit 109 in association with each other (operation S29). The data receiving unit 108 notifies the data processing unit 110 that the video data is registered (operation S30).

[3.3 Processing Flow at Time of Monitoring]

A processing flow at the time of monitoring will be described next by using FIG. 11. FIG. 11 is a flowchart illustrating a procedure performed at the time of monitoring. The monitoring unit 111 performs loop processing of operations S41 to S50 based on the number of incomplete groups. For example, when the loop processing based on the number of incomplete groups is started, the monitoring unit 111 refers to the status management information storage unit 107 and acquires group information of one of the incomplete groups (operation S42).

The monitoring unit 111 determines whether the current time is after the time slot end time of the monitoring-target group information (operation S43). If the current time is not after the time slot end time of the monitoring-target group information (operation S43: Yes), the processing proceeds to operation S50 and the loop processing is continued until the monitoring processing for all the pieces of monitoring-target group information is completed.

If the current time is after the time slot end time of the monitoring-target group information in operation S43 (operation S43: No), the monitoring unit 111 performs loop processing (operations S44 to S49) for the pieces of task information belonging to the group corresponding to the group information.

For example, the monitoring unit 111 refers to the status management information storage unit 107, and acquires the pieces of task information belonging to the group corresponding to the monitoring-target group information one by one (operation S45).

The monitoring unit 111 refers to the data storage unit 109 and determines whether video data associated with the task information is saved (operation S46). If the video data is saved (operation S46: Yes), the monitoring unit 111 updates the task state of the task information stored in the status management information storage unit 107 to “completed” (operation S47).

On the other hand, if, as a result of the monitoring unit 111 referring to the data storage unit 109 and determining whether the video data associated with the task information is saved, the video data is not saved (operation S46: No), the monitoring unit 111 performs predetermined delay processing (operation S48).

After the monitoring unit 111 finishes the processing of operation S47 or S48, the processing proceeds to operation S49, and the loop processing is continued until the processing for the pieces of monitoring-target task information is completed.

[4. One Aspect of Effects]

As described above, the distributed data collection system 10 according to the present embodiment sets a timeout time for each of the devices 30 that are targets of a transmission request, and performs grouping based on the timeout time. The distributed data collection system 10 generates task information including a task state of the device 30 and a group to which the device 30 belongs, and makes a data transmission request to the device 30. The distributed data collection system 10 receives data from the device 30, generates information indicating progress for the group to which the device 30 that is a transmission source of the data belongs, and manages the task state of the task information based on the information indicating the progress.

Since the distributed data collection system 10 according to the present embodiment performs grouping based on the timeout time and generates the information indicating the progress of the data reception status for each group, the distributed data collection system 10 just individually checks the progress of the tasks in accordance with the progress of each group. For example, the distributed data collection system 10 may focus on a group for which all the tasks belonging to the group are not completed and may individually check the progress of the tasks. Thus, the distributed data collection system 10 may efficiently check whether data is received from the devices 30. Consequently, the distributed data collection system may reduce resources used for monitoring a delay or the like.

For example, in a case where there are 300 monitoring-target tasks per second, if grouping is not performed, database accessing processing is to be performed 300 times per second for updating processing or reference processing when a case of the highest processing load is assumed.

On the other hand, a case is assumed where the distributed data collection system 10 according to the present embodiment monitors 300 tasks in the above-described manner. In this case, on the assumption that each single group includes 5 tasks, the tasks are divided into 60 groups. In this case, when the tasks of all the groups are completed, the database accessing processing is to be performed 60 times per second since updating is collectively performed in units of groups. Even if a delay occurs in a half the groups, the database accessing processing is to be performed 30 times (for 30 groups) per second for the updating processing and the database accessing is to be performed 150 times (30 groups×5 tasks) per second for the reference processing. For example, an amount of monitoring processing performed by the distributed data collection system 10 according to the present embodiment is greatly reduced as compared with the case where grouping is not performed.

In the embodiment described above, the case has been described in which the request accepting unit 102 allocates values to the respective devices 30 belonging to a group such that the exclusive OR of all the values allocated to the respective devices 30 is equal to a predetermined value. However, the configuration is not limited this. For example, the values may be allocated such that when a certain arithmetic operation (for example, addition) is performed on the values allocated to the respective devices 30 belonging to each group, a predetermined value (for example, 100) is obtained. Even in this case, the distributed data collection system 10 may generate the information indicating the progress of the data reception status for each group. Thus, the distributed data collection system 10 may efficiently check whether data is received from the devices 30.

As a method other than the embodiment described above, the number of tasks of each group may be stored in association with the corresponding group information, and, for each group, the data receiving unit 108 may update, as the progress information, the number of devices from which data has been received in response to receipt of the video data from the devices 30. For example, for each group, the distributed data collection system 10 may manage, as the progress information, the number of devices that have transmitted the video data. Even in this case, the distributed data collection system 10 may generate the information indicating the progress of the data reception status for each group. Thus, the distributed data collection system 10 may efficiently check whether data is received from the devices 30.

[5. Information Processing Program]

The various kinds of processing described in the embodiment above may be implemented as a result of a computer such as a personal computer or a workstation executing a program prepared in advance. An example of a computer that executes an information processing program according to the embodiment will be described below by using FIG. 12.

FIG. 12 is a diagram illustrating an example of a hardware configuration of the computer. As illustrated in FIG. 12, a computer 200 includes an operation unit 210a, a speaker 210b, a camera 210c, a display 220, and a communication unit 230. The computer 200 also includes a central processing unit (CPU) 250, a read-only memory (ROM) 260, a hard disk drive (HDD) 270, and a random-access memory (RAM) 280. The operation unit 210a, the speaker 210b, the camera 210c, the display 220, the communication unit 230, the CPU 250, the ROM 260, the HDD 270, and the RAM 280 are coupled to each other via a bus 240.

As illustrated in FIG. 12, the HDD 270 stores an information processing program 270a that implements functions that are substantially the same as those of the device information acquiring unit 101, the request accepting unit 102, the transmission scheduling unit 104, the transmission requesting unit 106, the data receiving unit 108, the data processing unit 110, and the monitoring unit 111 described in the embodiment above. This information processing program 270a may be integrated or separated, like the individual components of the device information acquiring unit 101, the request accepting unit 102, the transmission scheduling unit 104, the transmission requesting unit 106, the data receiving unit 108, the data processing unit 110, and the monitoring unit 111 illustrated in FIG. 2. For example, all the pieces of data described in the embodiment above are not necessarily stored in the HDD 270, and data to be used in processing may be stored in the HDD 270.

In such an environment, the CPU 250 reads out the information processing program 270a from the HDD 270 and loads the information processing program 270a to the RAM 280. As a result, the information processing program 270a functions as an information processing process 280a as illustrated in FIG. 12. The information processing process 280a loads various kinds of data read from the HDD 270, into an area allocated to the information processing process 280a in the storage area of the RAM 280, and performs various kinds of processing by using these loaded various kinds of data. For example, an example of the kinds of processing performed by the information processing process 280a includes the processing illustrated in FIGS. 9 to 11 and the like. All the processing units described in the embodiment above do not necessarily operate on the CPU 250, and processing units corresponding to the processing to be performed may be virtually implemented.

The information processing program 270a described above is not necessarily stored in the HDD 270 or the ROM 260 from the beginning. For example, the information processing program 270a may be stored in a “portable physical medium” such as a flexible disk (so-called an FD), a compact disc-read only memory (CD-ROM), a digital versatile disc (DVD), a magneto-optical disk, or an integrated circuit (IC) card, which is to be inserted into the computer 200. The computer 200 may acquire the information processing program 270a from the portable physical medium and may execute the program. Alternatively, the information processing program 270a may be stored in another computer or a server apparatus coupled to the computer 200 via a public line, the Internet, a LAN, or a wide area network (WAN), and the computer 200 may acquire the information processing program 270a from such an apparatus and execute the information processing program 270a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to:
classify tasks for data collection into groups, the tasks each being for a corresponding one of a plurality of devices;
allocate, for each of the groups, each of first values of which an accumulated value for all of the tasks in the group is equal to a predetermined value, to each of the tasks in the group;
accumulate, for each of the groups, the first value allocated to the task in a case where data that corresponds to the task is received from the device; and
update states of the tasks in the group to a completed state in a case where the accumulated value for the group is equal to the predetermined value.

2. The information processing apparatus according to claim 1, wherein the processor is configured to classify the tasks, based on timeout times set for each of the tasks.

3. The information processing apparatus according to claim 1, wherein the processor is configured to allocate each of bit strings of which exclusive OR for all of the devices classified into the group is equal to the predetermined value, to each of the devices in the group.

4. The information processing apparatus according to claim 3, wherein the predetermined value is a bit string in which all bits are equal to 0.

5. The information processing apparatus according to claim 1, wherein the processor is further configured to:
monitor a delay for the devices in the group in a case where the accumulated value for the group is not equal to the predetermined value and a progress of the task has passed a timeout time for the group.

6. The information processing apparatus according to claim 5, wherein the timeout time for the group is an end time of a time slot set for the group.

7. An information processing method for causing a computer to execute a process, the process comprising:
classifying tasks for data collection into groups, the tasks each being for a corresponding one of a plurality of devices;
allocating, for each of the groups, each of first values of which an accumulated value for all of the tasks in the group is equal to a predetermined value, to each of the tasks in the group;
accumulating, for each of the groups, the first value allocated to the task in a case where data that corresponds to the task is received from the device; and
updating states of the tasks in the group to a completed state in a case where the accumulated value for the group is equal to the predetermined value.

8. The information processing method according to claim 7, wherein the process classifies the tasks, based on timeout times set for each of the tasks.

9. The information processing method according to claim 7, wherein the process allocates each of bit strings of which exclusive OR for all of the devices classified into the group is equal to the predetermined value, to each of the devices in the group.

10. The information processing method according to claim 9, wherein the predetermined value is a bit string in which all bits are equal to 0.

11. The information processing method according to claim 7, further comprising:
monitoring a delay for the devices in the group in a case where the accumulated value for the group is not equal to the predetermined value and a progress of the task has passed a timeout time for the group.

12. The information processing method according to claim 11, wherein the timeout time for the group is an end time of a time slot set for the group.

13. A non-transitory computer-readable recording medium storing an information processing program for causing a computer to execute a process, the process comprising:
classifying tasks for data collection into groups, the tasks each being for a corresponding one of a plurality of devices;
allocating, for each of the groups, each of first values of which an accumulated value for all of the tasks in the group is equal to a predetermined value, to each of the tasks in the group;
accumulating, for each of the groups, the first value allocated to the task in a case where data that corresponds to the task is received from the device; and
updating states of the tasks in the group to a completed state in a case where the accumulated value for the group is equal to the predetermined value.

14. The non-transitory computer-readable recording medium according to claim 13, wherein the process classifies the tasks, based on timeout times set for each of the tasks.

15. The non-transitory computer-readable recording medium according to claim 13, wherein the process allocates each of bit strings of which exclusive OR for all of the devices classified into the group is equal to the predetermined value, to each of the devices in the group.

16. The non-transitory computer-readable recording medium according to claim 15, wherein the predetermined value is a bit string in which all bits are equal to 0.

17. The non-transitory computer-readable recording medium according to claim 13, the process further comprising:
monitoring a delay for the devices in the group in a case where the accumulated value for the group is not equal to the predetermined value and a progress of the task has passed a timeout time for the group.

18. The non-transitory computer-readable recording medium according to claim 17, wherein the timeout time for the group is an end time of a time slot set for the group.
